(19) United States
(12) Patent Application Publication
(10) Pub. No.: US 2019/0387755 A1
(43) Pub. Date: Dec. 26, 2019

(54) Formula of quality improvement for wheat flour-based frozen foods

(71) Applicant: Jiangnan University, Wuxi (CN)

(72) Inventors: Kexue ZHU, Wuxi (CN); Xiaona GUO, Wuxi (CN); Ludan HE, Wuxi (CN)

(21) Appl. No.: 16/557,135

(22) Filed: Aug. 30, 2019

Related U.S. Application Data
(63) Continuation of application No. PCT/CN2019/072515, filed on Jan. 21, 2019.

(30) Foreign Application Priority Data
Feb. 13, 2018 (CN) 201810148093.0

(51) Int. Cl. A21D 2/36; A23L 11/00; A23L 33/185

(52) U.S. Cl. CPC A21D 2/362; A23L 33/185; A23L 11/03

(57) ABSTRACT

The present disclosure relates to the formula of quality improvement for wheat flour-based frozen foods, which belongs to the technical field of food processing. The present disclosure discloses a quality improvement formula for wheat flour-based frozen food. The formula comprises soy protein isolate, soybean phospholipid, soybean oil and soybean polysaccharide. The formula can be used to improve the quality of wheat flour-based frozen food (frozen cooked noodles, frozen dumplings, frozen steamed bread, frozen steamed stuffed buns, etc.). The soybean base formula needs to be blended into water according to a proportion first, high-speed shearing and homogenizing, emulsification are performed, agitation and heating are then performed, so that compound soybean milk is made, and thereby the formula can take effect. The present disclosure can enable wheat flour-based frozen foods to have the advantages of good taste, rich nutrition, stable quality, long shelf-life, green, health, convenience in preparation, low cost and so on, and overcomes the technical bottleneck confronting the industrial development of wheat flour-based frozen food.

### TECHNICAL FIELD

The disclosure herein relates to the field of the formula of quality improvement for wheat flour-based frozen foods, which belongs to the technical field of food processing.

### BACKGROUND

With the development of the society and the acceleration of the pace of life, convenient and fast frozen food has become more and more popular, so there is a huge consumer market for considering wheat flour-based frozen foods as convenient staples. However, problems (such as unstable quality, severe quality deterioration in the process of refrigeration, etc.) widely exist in frozen food (such as frozen dumplings, frozen steamed bread, etc.) which is highly favored among consumers.

In particular, the problem of deterioration in refrigeration always exists in frozen cooked noodles, that is, as the time of refrigeration goes on, both the taste and appearance state of reheated ordinary frozen cooked noodles show a tendency to deteriorate, so it is highly desirable to find a method which can effectively improve the edible quality and refrigeration stability of frozen cooked noodles, so that frozen cooked noodles can have the advantages of good taste, rich nutrition, stable quality, long shelf-life, etc.

Enterprises often employ some low-efficiency, high-cost means to solve the aforementioned problems, for example, using a variety of additives, using high-quality wheat flour materials, using cold-chain circulation for food, etc., but seldom adopt proper scientific researches to specifically control the key points of quality change.

Moreover, although some improvement techniques and methods that already exist at present have improved the quality and shelf life of wheat flour-based frozen food to a certain degree, the defects of complex additive composition and high economic cost still exist. If the additive formula of a product is too complex, consumers are often worried about whether food is green and healthy, and additives have impact on the healthy, green new consumption concept of consumers; if products are added with soup stock and vegetables, product costs are too high, part of consumers cannot accept high-priced frozen food, and part of manufacturers cannot accept high costs as well. The two aforementioned points make processing techniques of wheat flour-based frozen food provided by the prior improvement techniques inapplicable to actual industrial production.

### SUMMARY

The soybean base is a mixed base which is obtained by compounding a variety of main components extracted from soybeans according to a certain proportion, and is a low-cost natural extracted base which has a variety of functional properties (such as stability, water-holding capacity, emulsification, etc.) after undergoing certain technological process. It is worth trying to apply the soybean base in wheat flour-based frozen food to solve some current technical problems confronting wheat flour-based frozen food, so that wheat flour-based frozen foods can have the advantages of good taste, rich nutrition, green, health, stable quality, long shelf-life and so on and be applicable to industrial production.

However, due to the difference between the functional properties of soy protein and wheat protein, whether the interaction between a variety of exogenous soybean base formula components can have a synergistic effect on both the eating quality and frozen storage stability of wheat flour-based frozen foods still needs to be further verified; how to formulate exogenous formula components also needs to be further researched; and corresponding specific preparation conditions and methods also need to be researched.

The objective of the present disclosure is to provide a quality improvement formula for wheat flour-based frozen foods, particularly a quality improvement formula for soybean base wheat flour-based frozen foods, which can greatly improve the quality of wheat flour-based frozen foods, i.e. the taste and appearance state of reheated wheat flour-based frozen foods, and is embodied in improving the hardness, elasticity, chewiness and other properties of reheated wheat flour-based frozen foods and increasing the eating quality and frozen storage stability of wheat flour-based frozen foods, so that produced formula-improved wheat flour-based frozen foods can have the advantages of good taste, rich nutrition, stable quality, long shelf-life, green, health, convenience in preparation, low cost and so on. Wheat flour-based frozen foods made from the formula appears smooth and compact, tastes chewy and elastic, and is highly stable in frozen storage, and the shelf life is six months or more. With the characteristics of easy component obtainment, easiness in storage, convenience in use and so on, the formula is highly suitable for being applied in industrial production, and can overcome the current technical bottleneck confronting the industrial development of wheat flour-based frozen foods.

Mainly by blending four types of main components (soy protein isolate, soybean phospholipid, soybean oil and soybean polysaccharide) of the soybean base according to a certain proportion and carrying out homogenization and emulsification in combination with vacuum dough mixing, refrigeration and other processing conditions, the technical solution of the present disclosure effectively improves the taste of wheat flour-based frozen foods and increases its frozen storage stability.

The present disclosure provides a quality improvement formula for wheat flour-based frozen foods, and the formula is a soybean base formula, which comprises soy protein isolate, soybean phospholipid, soybean oil and soybean polysaccharide.

In one embodiment of the present disclosure, the protein content of the soy protein isolate is 90 percent or more; the soy protein isolate may be substituted by soy protein concentrate with a protein content of 70 to 90 percent; the soybean phospholipid may be substituted by rapeseed phosphatide or egg lecithin; the soybean oil may be substituted by vegetable oil with rich unsaturated fatty acid, such as palm oil, peanut oil, rapeseed oil, etc.; and the soybean polysaccharide is soluble soybean polysaccharide specified in GB 2760-2014.

The quality improvement formula for wheat flour-based frozen foods provided by the present disclosure can be applied to wheat flour-based frozen foods, such as frozen cooked noodles, frozen dumplings, frozen steamed bread, frozen steamed stuffed buns, frozen rice dumpling, etc.

The present disclosure provides a usage of the quality improvement formula for wheat flour-based frozen foods which comprises the following steps: soybean base components are dissolved in water first, and after processing by a high-speed homogenizer, agitation and heating are performed in boiling water bath, so that compound soybean milk is made; and the made compound soybean milk is then added into wheat flour.

In one embodiment of the present disclosure, the soybean base components are dissolved in water, and after 1 to 2 minutes of processing by the high-speed homogenizer under a rotational speed of 10000 to 15000 r/min, agitation and heating for uniform blending are performed under a speed of 500 to 1000 r/min, so that the compound soybean milk is made.

The present disclosure provides a soybean base wheat flour-based frozen foods formula, the formula comprises wheat flour, water, salt and a soybean base formula, and the soybean base formula comprises soy protein isolate, soybean phospholipid, soybean oil and soybean polysaccharide.

In one embodiment of the present disclosure, the mass of the soy protein isolate is 1.0 to 5.0 percent of the total mass of the wheat flour, the mass of the soybean phospholipid is 0.2 to 1.0 percent of the total mass of the wheat flour, the mass of the soybean oil is 0.5 to 2.0 percent of the total mass of the wheat flour, the mass of the soybean polysaccharide is 0.5 to 1.0 percent of the total mass of the wheat flour, the mass of the salt is 0 to 1.0 percent of the total mass of the wheat flour, and the mass of the water is 45 to 50 percent of the total mass of the wheat flour.

In one embodiment of the present disclosure, preferably, the mass ratio of the soy protein isolate to the soybean phospholipid to the soybean oil to the soybean polysaccharide is (4-6):(1-2):(2-4):(1-2).

In one embodiment of the present disclosure, a preparation method for frozen cooked soybean base noodles comprises the following steps:

Step 1: wheat flour, salt, soy protein isolate, soybean phospholipid, soybean oil and soybean polysaccharide are weighed according to a quality improvement formula proportion;

Step 2: the soybean base components are dissolved in water, and after processing by a high-speed homogenizer, agitation and heating are performed in boiling water bath, so that compound soybean milk is made;

Step 3: a certain proportion of salt is added into the compound soybean milk made in step 2, dissolved and uniformly blended for further use;

Step 4: the wheat flour is added into a vacuum dough mixing machine, the compound soybean milk made in step 3 is added, vacuum dough mixing is performed under the condition that the vacuum degree is −0.05 to −0.09 MPa, and the time taken by vacuum dough mixing is 7 to 8 minutes;

Step 5: the dough made in step 4 rested and then is rolled to form a dough sheet, which is cut into noodles;

Step 6: the noodles made in step 5 sequentially undergo high-humidity continuous steaming, cyclic showering, continuous cooking and washing and cooling;

Step 7: after being quickly frozen, the noodles made in step 6 are packaged and refrigerated, and thereby the quality-improved frozen cooked noodles are made.

In step 2, the soybean base components are dissolved in water, and after 1 to 2 minutes of processing by the high-speed homogenizer under a rotational speed of 10000 to 15000 r/min, agitation and heating for uniform blending are performed under a speed of 500 to 1000 r/min, so that the compound soybean milk is made.

In vacuum dough mixing of step 4, preblend is performed first for 20 to 30 seconds, agitation is then performed under 100 to 120 Hz for 120 to 130 seconds, and finally agitation is performed under 50 to 60 Hz for 300 to 350 seconds, and thereby a dough is made.

In step 5, after rest under room temperature for 15 to 30 minutes, the made dough is put into a strand machine and rolled to form a dough sheet with a thickness of 2 to 3 mm, which is cut into noodles.

In step 6, the made noodles undergo high-humidity continuous steaming under 95 to 100° C. for 30 to 90 seconds, subsequently, atomized water spraying is performed first, waterfall showering is then performed, water temperature is controlled at about 30° C., the noodles are then cooked in boiling water for 3 to 4 minutes, and finally the noodles are put into 0 to 5° C. iced water and cooled for 1 to 2 minutes.

In step 7, the made noodles are put into a tunnel freezer and quickly frozen for 30 to 60 minutes, and after the center temperature of the noodles reaches −18° C., the noodles are packaged and refrigerated, so that the quality-improved frozen cooked noodles are made.

In one embodiment of the present disclosure, a preparation method for soybean base frozen steamed bread comprises the following steps:

Step 1: wheat flour, salt, soy protein isolate, soybean phospholipid, soybean oil and soybean polysaccharide are weighed according to a quality improvement formula proportion;

Step 2: the soybean base components are dissolved in water, and after processing by a high-speed homogenizer, agitation and heating are performed in boiling water bath, so that compound soybean milk is made;

Step 3: a certain proportion of salt is added into the compound soybean milk made in step 2, dissolved and uniformly blended for further use;

Step 4: the wheat flour is added into a vacuum dough mixing machine, the compound soybean milk made in step 3 is added, vacuum dough mixing is performed under the condition that the vacuum degree is −0.05 to −0.09 MPa, and the time taken by vacuum dough mixing is 7 to 8 minutes;

Step 5: the dough made in step 4 is put into a proof cabinet and fermented, secondary dough kneading is performed after fermentation, and in the process of dough kneading, wheat flour for first dough mixing is added;

Step 6: the dough made in step 5 is agitated under low speed, and then undergoes manual dough kneading, shaping and rest;

Step 7: the dough made in step 6 is steamed for 30 minutes, cooled, quickly frozen, packaged and stored under −18° C.

In step 2, the soybean base components are dissolved in water, and after 1 to 2 minutes of processing by the high-speed homogenizer under a rotational speed of 10000 to 15000 r/min, agitation and heating for uniform blending are performed under a speed of 500 to 1000 r/min, so that the compound soybean milk is obtained.

In vacuum dough mixing of step 4, preblend is performed first for 20 to 30 seconds, agitation is then performed under 100 to 120 Hz for 120 to 130 seconds, and finally agitation is performed under 50 to 60 Hz for 300 to 350 seconds, and thereby a dough is made.

In step 5, after being put into a 25° C. proof cabinet with a relative humidity of 55% and fermented for 60 minutes, the obtained dough undergoes secondary dough kneading, wheat flour for first dough mixing is added in the process of dough kneading, and the mass of the newly added wheat flour is 10% of the mass of the wheat flour.

In step 6, the made dough is agitated under low speed for 300 seconds, and then undergoes manual dough kneading, shaping and rest; and the conditions of rest are as follows: temperature is 38° C., relative humidity is 85%, and time is 30 minutes.

In step 7, the made dough ball is steamed for 30 minutes; after being cooled, the steamed bread is put into a tunnel freezer and quickly frozen for 30 to 60 minutes, so that the center temperature of the steamed bread reaches −18° C.; and subsequently, packaging and refrigeration are performed, so that the quality-improved frozen steamed bread is made.

Compared with the prior art, the advantages of the present disclosure are as follows:

(1) The quality improvement formula provided by the present disclosure can greatly improve the quality of frozen wheat-based products, the frozen cooked noodles made according to the formula are good in quality and high in nutritional value, taste chewy and elastic, and have the light flavor of soybean milk, inviting color and glossiness and high frozen storage stability in comparison with ordinary frozen cooked noodles, the shelf life of the product is prolonged, the quality of conventional products will significantly decrease in 6 to 8 weeks, but the frozen cooked noodles which are made by adding the soybean base improvement formula according to the specification can still keep a good taste after being refrigerated for 20 to 24 weeks or more;

(2) The components of the quality improvement formula provided by the present disclosure are all industrially obtained from natural soybeans, and compared with the method of adding additives (such as a variety of preservatives, etc.) in frozen food in the prior art, the quality improvement formula provided by the present disclosure is safe, nonpoisonous, green, healthy, mature in process and high in economic benefit, meeting the consumption concept of modern people;

(3) The quality improvement formula provided by the present disclosure has the characteristics of simple composition, convenience in use, high effect, easy soybean base obtainment and easiness in storage, so the quality improvement formula provided by the present disclosure is low in cost and highly suitable for being applied in the industrial production of wheat flour-based frozen foods.

### BRIEF DESCRIPTION OF FIGURES

FIG. 1 is a relationship graph of tensile strength changes of quality-improved frozen cooked noodles made by examples 1 to 4 and frozen cooked noodles made by comparative examples 1 to 5 based on the passage of frozen storage time;

FIG. 2 is a relationship graph of comprehensive sensory score changes of the quality-improved frozen cooked noodles made by examples 1 to 4 and the frozen cooked noodles made by comparative examples 1 to 5 according to the passage of frozen storage time;

FIG. 3 is micrographs of morphologies and distributions of ice crystals in the frozen cooked noodles made by examples 1 to 3 and the frozen cooked noodles made by comparative examples 1 to 3;

FIG. 4 is micrographs of morphologies and distributions of ice crystals in four types of frozen cooked noodles made by comparative example 9.

### DETAILED DESCRIPTION

Taking frozen cooked noodles as an example, the operating method and technical effects of the present disclosure will be further described below in reference to specific examples and comparative examples.

### EXAMPLE 1

1. A quality-improved frozen cooked noodle formula of the present example is as follows: 600 g of wheat flour, 280 g of water, 6.0 g of salt, 18 g of soy protein isolate, 4 g of soybean phospholipid, 12 g of soybean oil and 6 g of soybean polysaccharide.

2. A preparation method for the quality-improved frozen cooked noodles of the present example comprises the following steps:

the aforementioned formula components are dissolved into the water, homogenizing, emulsification and sufficiently blended, and the blend and 600 g of wheat flour are then mixed into a vacuum dough mixing machine and agitated for 445 seconds; after being taken out and placed under room temperature for rest for 15 minutes, the dough is rolled into a 2.0 mm dough sheet, the dough sheet is cut into noodles, the noodles are weighed, steamed for 1 minute, showered, cooked for 4 minutes, cooled, quickly frozen, packaged and stored under −18° C., and the following indexes are periodically measured.

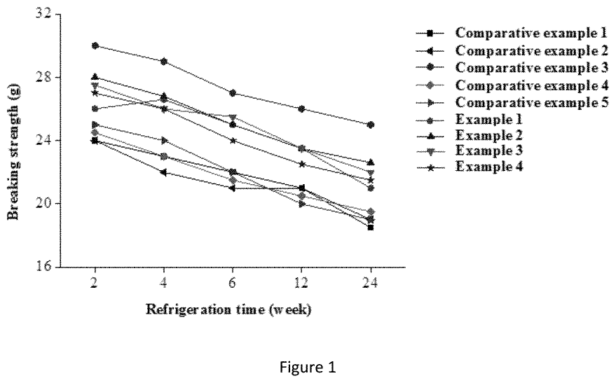

Texture Indexes: including a texture profile parameter and a tensile parameter, and representing the hardness, elasticity, tensile strength and other properties of noodles (see Table 1 and FIG. 1);

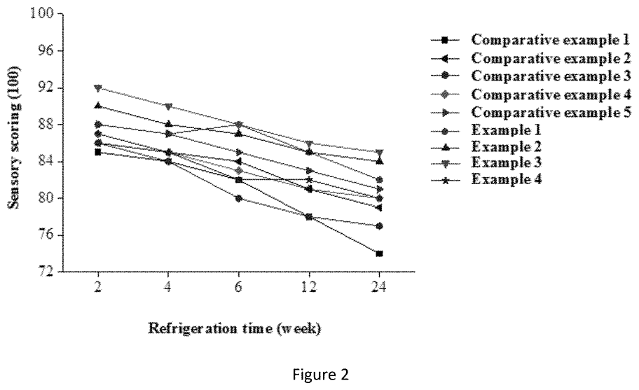

Sensory Indexes: color and glossiness, smell, appearance state, etc., and taking comprehensive scores for comparison (see FIG. 2).

Stored under the condition of −18° C., the improved frozen cooked noodles made by the present example can be stored for 12 to 24 weeks, having inviting color and glossiness, good appearance state, chewiness, elasticity, acceptable palatability and high nutrition retention rate.

### EXAMPLE 2

1. A quality-improved frozen cooked noodle formula of the present example is as follows: 600 g of wheat flour, 280 g of water, 6.0 g of salt, 12 g of soy protein isolate, 4 g of soybean phospholipid, 8 g of soybean oil and 4 g of soybean polysaccharide.

2. A preparation method for the quality-improved frozen cooked noodles of the present example comprises the following steps:

the aforementioned formula components are dissolved into the water, homogenizing, emulsification and sufficiently blended, and the blend and 600 g of wheat flour are then mixed into a vacuum dough mixing machine and agitated for 445 seconds; after being taken out and placed under room temperature for rest for 15 minutes, the dough is rolled into a 2.0 mm dough sheet, the dough sheet is cut into noodles, the noodles are weighed, steamed for 1 minute, showered, cooked for 4 minutes, cooled, quickly frozen, packaged and stored under −18° C., and the following indexes are periodically measured.

Texture Indexes: including a texture profile parameter and a tensile parameter, and representing the hardness, elasticity, tensile strength and other properties of noodles (see Table 1 and FIG. 1);

Sensory Indexes: color and glossiness, smell, appearance state, etc., and taking comprehensive scores for comparison (see FIG. 2).

Stored under the condition of −18° C., the improved frozen cooked noodles made by the present example can be stored for 12 to 24 weeks, having inviting color and glossiness, good appearance state, chewiness, elasticity, acceptable palatability and high nutrition retention rate.

### EXAMPLE 3

1. A quality-improved frozen cooked noodle formula of the present example is as follows: 600 g of wheat flour, 280 g of water, 6.0 g of salt, 10 g of soy protein concentrate, 4 g of egg lecithin, 8 g of peanut oil, and 4 g of soybean polysaccharide.

2. A preparation method for the quality-improved frozen cooked noodles of the present example comprises the following steps:

the aforementioned formula components are dissolved into the water, homogenizing, emulsification and sufficiently blended, and the blend and 600 g of wheat flour are then mixed into a vacuum dough mixing machine and agitated for 445 seconds; after being taken out and placed under room temperature for rest for 15 minutes, the dough is rolled into a 2.0 mm dough sheet, the dough sheet is cut into noodles, the noodles are weighed, steamed for 1 minute, showered, cooked for 4 minutes, cooled, quickly frozen, packaged and stored under −18° C., and the following indexes are periodically measured.

Texture Indexes: including a texture profile parameter and a tensile parameter, and representing the hardness, elasticity, tensile strength and other properties of noodles (see Table 1 and FIG. 1);

Sensory Indexes: color and glossiness, smell, appearance state, etc., and taking comprehensive scores for comparison (see FIG. 2).

Stored under the condition of −18° C., the improved frozen cooked noodles made by the present example can be stored for 12 to 24 weeks, having inviting color and glossiness, good appearance state, chewiness, elasticity, acceptable palatability and high nutrition retention rate.

### EXAMPLE 4

1. A quality-improved frozen cooked noodle formula of the present example is as follows: 600 g of wheat flour, 280 g of water, 6.0 g of salt, 10 g of soy protein concentrate, 4 g of egg lecithin, 8 g of rapeseed oil, and 4 g of soybean polysaccharide.

2. A preparation method for the quality-improved frozen cooked noodles of the present example comprises the following steps:

the aforementioned formula components are dissolved into the water, homogenizing, emulsification and sufficiently blended, and the blend and 600 g of wheat flour are then mixed into a vacuum dough mixing machine and agitated for 445 seconds; after being taken out and placed under room temperature for standing for 15 minutes, the dough is rolled into a 2.0 mm dough sheet, the dough sheet is cut into noodles, the noodles are weighed, steamed for 1 minute, showered, cooked for 4 minutes, cooled, quickly frozen, packaged and stored under −18° C., and the following indexes are periodically measured.

Texture Indexes: including a texture profile parameter and a tensile parameter, and representing the hardness, elasticity, tensile strength and other properties of noodles (see table 1 and FIG. 1);

Sensory Indexes: color and glossiness, smell, appearance state, etc., and taking comprehensive scores for comparison (see FIG. 2).

Stored under the condition of −18° C., the improved frozen cooked noodles made by the present example can be stored for 12 to 24 weeks, having inviting color and glossiness, good appearance state, chewiness, elasticity, acceptable palatability and high nutrition preservation rate.

### EXAMPLE 5

1. A quality-improved frozen steamed bread formula of the present example is as follows: 600 g of wheat flour, 300 g of water, 3.0 g of yeast, 12 g of soy protein concentrate, 4 g of soybean phospholipid, 6 g of soybean oil and 4 g of soybean polysaccharide.

2. A preparation method for the quality-improved frozen steamed bread of the present example comprises the following steps:

the aforementioned formula components are dissolved into the water, homogenizing, emulsification and sufficiently blended, and the blend and 600 g of wheat flour are then mixed into a vacuum dough mixing machine and agitated for 300 seconds; after being put into a 25° C. proof cabinet with a relative humidity of 55% and fermented for 60 minutes, the obtained dough undergoes secondary dough kneading, wheat flour for first dough mixing is added in the process of dough kneading, and the mass of the newly added wheat flour is 10% of the mass of the wheat flour; the made dough is agitated under ordinary low speed for 300 seconds, and then undergoes manual dough kneading, shaping and rest; and the conditions of rest are as follows: temperature is 38° C., relative humidity is 85%, and time is 30 minutes; the made steamed bread is steamed for 30 minutes; cooled, quickly frozen, packaged and stored under −18° C., and the following indexes are periodically measured.

Texture Indexes: including a texture profile parameter and volume, and representing the hardness, elasticity, chewiness and other properties of steamed bread (see Table 2);

Sensory Indexes: color and glossiness, smell, appearance state, etc., and taking comprehensive scores for comparison (see Table 2).

Stored under the condition of −18° C., the improved frozen cooked noodles made by the present example can be stored for 12 to 24 weeks, having inviting color and glossiness, good appearance state, high specific volume, delicate and chewy taste, and high nutrition retention rate.

### EXAMPLE 6

1. A quality-improved frozen steamed bread formula of the present example is as follows: 600 g of wheat flour, 300 g of water, 3.0 g of yeast, 12 g of soy protein concentrate, 4 g of egg lecithin, 6 g of peanut oil and 4 g of soybean polysaccharide.

2. A preparation method for the quality-improved frozen steamed bread of the present example comprises the following steps:

the aforementioned formula components are dissolved into the water, homogenizing, emulsification and sufficiently blended, and the blend and 600 g of wheat flour are then mixed into a vacuum dough mixing machine and agitated for 300 seconds; after being put into a 25° C. proof cabinet with a relative humidity of 55% and fermented for 60 minutes, the obtained dough undergoes secondary dough kneading, wheat flour for first dough mixing is added in the process of dough kneading, and the mass of the newly added wheat flour is 10% of the mass of the wheat flour; the made dough is agitated under ordinary low speed for 300 seconds, and then undergoes manual dough kneading, shaping and rest; and the conditions of rest are as follows: temperature is 38° C., relative humidity is 85%, and time is 30 minutes; the made steamed bread is steamed for 30 minutes; cooled, quickly frozen, packaged and stored under −18° C., and the following indexes are periodically measured.

Texture Indexes: including a texture profile parameter and volume, and representing the hardness, elasticity, chewiness and other properties of steamed bread (see Table 2);

Sensory Indexes: color and glossiness, smell, appearance state, etc., and taking comprehensive scores for comparison (see Table 2).

Stored under the condition of −18° C., the improved frozen cooked noodles made by the present example can be stored for 12 to 24 weeks, having inviting color and glossiness, good appearance state, high specific volume, delicate and chewy taste, and high nutrition retention rate.

### COMPARATIVE EXAMPLE 1

1. A quality-improved frozen cooked noodle formula of the present example is as follows: 600 g of wheat flour, 280 g of water, 6.0 g of salt.

2. A preparation method for the quality-improved frozen cooked noodles of the present example comprises the following steps:

the aforementioned formula components are dissolved into the water, homogenizing, emulsification and sufficiently blended, and the blend and 600 g of wheat flour are then mixed into a vacuum dough mixing machine and agitated for 445 seconds; after being taken out and placed under room temperature for rest for 15 minutes, the dough is rolled into a 2.0 mm dough sheet, the dough sheet is cut into noodles, the noodles are weighed, steamed for 1 minute, showered, cooked for 4 minutes, cooled, quickly frozen, packaged and stored under −18° C., and the following indexes are periodically measured.

Texture Indexes: including a texture profile parameter and a tensile parameter, and representing the hardness, elasticity, tensile strength and other properties of noodles (see Table 1 and FIG. 1);

Sensory Indexes: color and glossiness, smell, appearance state, etc., and taking comprehensive scores for comparison (see FIG. 2).

Stored under the condition of −18° C., frozen cooked noodles made by the present comparative example can only be stored for 6 to 8 weeks, having high whiteness, good appearance state, chewiness, elasticity, acceptable palatability and high nutrition retention rate; compared with the shelf lives of examples 1 to 4, the shelf life is significantly shortened, and when storage time is longer than 6 to 8 weeks, the quality decreases remarkably.

### COMPARATIVE EXAMPLE 2

1. A quality-improved frozen cooked noodle formula of the present example is as follows: 600 g of wheat flour, 280 g of water, 6.0 g of salt, 5 g of soy protein isolate, 2 g of soybean phospholipid, 4 g of soybean oil and 2 g of soybean polysaccharide.

2. A preparation method for the quality-improved frozen cooked noodles of the present example comprises the following steps:

the aforementioned formula components are dissolved into the water, homogenizing, emulsification and sufficiently blended, and the blend and 600 g of wheat flour are then mixed into a vacuum dough mixing machine and agitated for 445 seconds; after being taken out and placed under room temperature for rest for 15 minutes, the dough is rolled into a 2.0 mm dough sheet, the dough sheet is cut into noodles, the noodles are weighed, steamed for 1 minute, showered, cooked for 4 minutes, cooled, quickly frozen, packaged and stored under −18° C., and the following indexes are periodically measured.

Texture Indexes: including a texture profile parameter and a tensile parameter, and representing the hardness, elasticity, tensile strength and other properties of noodles (see Table 1 and FIG. 1);

Sensory Indexes: color and glossiness, smell, appearance state, etc., and taking comprehensive scores for comparison (see FIG. 2).

Stored under the condition of −18° C., frozen cooked noodles made by the present comparative example can only be stored for 8 to 12 weeks, and compared with the improvement effects of comparative example 1 and examples 1 to 4, the improvement effect is not significant.

### COMPARATIVE EXAMPLE 3

1. A quality-improved frozen cooked noodle formula of the present example is as follows: 600 g of wheat flour, 280 g of water, 6.0 g of salt, 24 g of soy protein isolate, 16 g of soybean phospholipid, 8 g of rapeseed oil and 4 g of soybean polysaccharide.

2. A preparation method for the quality-improved frozen cooked noodles of the present example comprises the following steps:

the aforementioned formula components are dissolved into the water, homogenizing, emulsification and sufficiently blended, and the blend and 600 g of wheat flour are then mixed into a vacuum dough mixing machine and agitated for 445 seconds; after being taken out and placed under room temperature for rest for 15 minutes, the dough is rolled into a 2.0 mm dough sheet, the dough sheet is cut into noodles, the noodles are weighed, steamed for 1 minute, showered, cooked for 4 minutes, cooled, quickly frozen, packaged and stored under −18° C., and the following indexes are periodically measured.

Texture Indexes: including a texture profile parameter and a tensile parameter, and representing the hardness, elasticity, tensile strength and other properties of noodles (see table 1 and FIG. 1);

Sensory Indexes: color and glossiness, smell, appearance state, etc., and taking comprehensive scores for comparison (see FIG. 2).

When frozen cooked noodles made by the present comparative example are stored under the condition of −18° C., the texture characteristics obviously become bad, the sensory score is obviously low; and in comparison with comparative example 1, comparative example 2 and examples 1 to 4, the adopted formula proportion is inaccurate, and the improvement effect is not significant if the formula proportion is too high or too low.

### COMPARATIVE EXAMPLE 4

1. A quality-improved frozen cooked noodle formula of the present example is as follows: 600 g of wheat flour, 280 g of water, 6.0 g of salt, 10 g of soy protein concentrate, 4 g of egg lecithin, 16 g of rapeseed oil and 10 g of soybean polysaccharide.

2. A preparation method for the quality-improved frozen cooked noodles of the present example comprises the following steps:

the aforementioned formula components are dissolved into the water, homogenizing, emulsification and sufficiently blended, and the blend and 600 g of wheat flour are then mixed into a vacuum dough mixing machine and agitated for 445 seconds; after being taken out and placed under room temperature for rest for 15 minutes, the dough is rolled into a 2.0 mm dough sheet, the dough sheet is cut into noodles, the noodles are weighed, steamed for 1 minute, showered, cooked for 4 minutes, cooled, quickly frozen, packaged and stored under −18° C., and the following indexes are periodically measured.

Texture Indexes: including a texture profile parameter and a tensile parameter, and representing the hardness, elasticity, tensile strength and other properties of noodles (see Table 1 and FIG. 1);

Sensory Indexes: color and glossiness, smell, appearance state, etc., and taking comprehensive scores for comparison (see FIG. 2).

When frozen cooked noodles made by the present comparative example are stored under the condition of −18° C., the texture characteristics obviously become bad, the sensory score is obviously low; and in comparison with comparative example 1, comparative example 2, comparative example 3 and examples 1 to 4, the adopted formula proportion of any component is inaccurate, and the improvement effect is not significant if the formula proportion of any component is too high or too low.

### COMPARATIVE EXAMPLE 5

1. A quality-improved frozen cooked noodle formula of the present example is as follows: 600 g of wheat flour, 280 g of water, 6.0 g of salt, 10 g of soy protein concentrate, 4 g of egg lecithin, 8 g of rapeseed oil and 4 g of soybean polysaccharide.

2. A preparation method for the quality-improved frozen cooked noodles of the present example comprises the following steps:

the aforementioned formula components are dissolved into the water, homogenizing, emulsification and sufficiently blended, and the blend and 600 g of wheat flour are then mixed into a vacuum dough mixing machine and agitated for 445 seconds; after being taken out and placed under room temperature for rest for 15 minutes, the dough is rolled into a 2.0 mm dough sheet, the dough sheet is cut into noodles, the noodles are weighed, steamed for 1 minute, showered, cooked for 4 minutes, cooled, quickly frozen, packaged and stored under −18° C., and the following indexes are periodically measured.

Texture Indexes: including a texture profile parameter and a tensile parameter, and representing the hardness, elasticity, tensile strength and other properties of noodles (see Table 1 and FIG. 1);

Sensory Indexes: color and glossiness, smell, appearance state, etc., and taking comprehensive scores for comparison (see FIG. 2).

Stored under the condition of −18° C., frozen cooked noodles made by the present comparative example can be stored for 8 to 12 weeks, and do not show good sensory quality and texture quality during frozen storage, which indicates that the preparation method and usage of the formula are not standard, failing to reflect excellent functional properties, and therefore cannot optimally increase the quality of the frozen cooked noodles.

### COMPARATIVE EXAMPLE 6

1. A quality-improved frozen steamed bread formula of the present example is as follows: 600 g of wheat flour, 300 g of water, 3.0 g of yeast.

2. A preparation method for the quality-improved frozen steamed bread of the present example comprises the following steps:

the aforementioned formula components are dissolved into the water, homogenizing, emulsification and sufficiently blended, and the blend and 600 g of wheat flour are then mixed into a vacuum dough mixing machine and agitated for 300 seconds; after being taken out and fermented in a proof cabinet at 25° C. and 55% relative humidity for 60 min, the blend and 600 g of wheat flour are then mixed into a vacuum dough mixing machine and agitated for 300 seconds; after being taken out and fermented in a proof cabinet at 25° C. and 55% relative humidity for 60 min, the obtained dough undergoes secondary dough kneading, wheat flour for first dough mixing is added in the process of dough kneading, and the mass of the newly added wheat flour is 10% of the mass of the wheat flour; the made dough is agitated under ordinary low speed for 300 seconds, and then undergoes manual dough kneading, shaping and rest; and the conditions of rest are as follows: temperature is 38° C., relative humidity is 85%, and time is 30 minutes; the made steamed bread is steamed for 30 minutes; cooled, quickly frozen, packaged and stored under −18° C., and the following indexes are periodically measured.

Texture Indexes: including a texture profile parameter and volume, and representing the hardness, elasticity, chewiness and other properties of steamed bread (see Table 2);

Sensory Indexes: color and glossiness, smell, appearance state, etc., and taking comprehensive scores for comparison (see Table 2).

Stored under the condition of −18° C., frozen steamed bread made by the present comparative example can be stored for 8 to 16 weeks, both the color and glossiness and the specific volume are ordinary, wrinkles are visible on the skin, and the taste is slightly sticky for teeth. Compared with those of examples 5 to 6, the frozen steamed bread tastes bad, and is poor in frozen storage stability, and after 8 to 12 weeks of frozen storage, the quality decreases significantly.

### COMPARATIVE EXAMPLE 7

1. A quality-improved frozen steamed bread formula of the present example is as follows: 600 g of wheat flour, 300 g of water, 3.0 g of yeast, 20 g of soy protein concentrate, 8 g of soybean phospholipid, 8 g of soybean oil and 8 g of soybean polysaccharide.

2. A preparation method for the quality-improved frozen cooked noodles of the present example comprises the following steps:

the aforementioned formula components are dissolved into the water, homogenizing, emulsification and sufficiently blended, and the blend and 600 g of wheat flour are then mixed into a vacuum dough mixing machine and agitated for 300 seconds; after being taken out and fermented in a proof cabinet at 25° C. and 55% relative humidity for 60 min, the obtained dough undergoes secondary dough kneading, wheat flour for first dough mixing is added in the process of dough kneading, and the mass of the newly added wheat flour is 10% of the mass of the wheat flour; the made dough is agitated under ordinary low speed for 300 seconds, and then undergoes manual dough kneading, shaping and rest; and the conditions of rest are as follows: temperature is 38° C., relative humidity is 85%, and time is 30 minutes; the made steamed bread is steamed for 30 minutes; cooled, quickly frozen, packaged and stored under −18° C., and the following indexes are periodically measured.

Texture Indexes: including a texture profile parameter and volume, and representing the hardness, elasticity, chewiness and other properties of steamed bread (see Table 2);

Sensory Indexes: color and glossiness, smell, appearance state, etc., and taking comprehensive scores for comparison (see Table 2).

Stored under the condition of −18° C., frozen steamed bread made by the present comparative example can be stored for 8 to 16 weeks; compared with those of examples 5 to 6 and comparative example 6, the frozen steamed bread is yellowish and poor in elasticity and chewiness and has breaks on the skin and small specific volume, and this may be because too much added soybean protein will dilute gluten, failing to achieve the effects of improving the quality of the steamed bread and increasing the gas-retaining property of the steamed bread; and excessive exogenous additives (such as soybean phospholipid, soybean oil, etc.) can also destroy the structure of the system, so the effect is poor.

### COMPARATIVE EXAMPLE 8

1. A quality-improved frozen steamed bread formula of the present example is as follows: 600 g of wheat flour, 300 g of water, 3.0 g of yeast, 5 g of soy protein concentrate, 2 g of soybean phospholipid, 4 g of soybean oil and 4 g of soybean polysaccharide.

2. A preparation method for the quality-improved frozen steamed bread of the present example comprises the following steps:

the aforementioned formula components are dissolved into the water, homogenizing, emulsification and sufficiently blended, and the blend and 600 g of wheat flour are then mixed into a vacuum dough kneading machine and agitated for 300 seconds; after being taken out and fermented in a proof cabinet at 25° C. and 55% relative humidity for 60 min, the obtained dough undergoes secondary dough kneading, wheat flour for first dough mixing is added in the process of dough kneading, and the mass of the newly added wheat flour is 10% of the mass of the wheat flour; the made dough is agitated under ordinary low speed for 300 seconds, and then undergoes manual dough kneading, shaping and rest; and the conditions of rest are as follows: temperature is 38° C., relative humidity is 85%, and time is 30 minutes; the made steamed bread is steamed for 30 minutes; cooled, quickly frozen, packaged and stored under −18° C., and the following indexes are periodically measured.

Texture Indexes: including a texture profile parameter and volume, and representing the hardness, elasticity, chewiness and other properties of steamed bread (see Table 2);

Sensory Indexes: color and glossiness, smell, appearance state, etc., and taking comprehensive scores for comparison (see Table 2).

Stored under the condition of −18° C., frozen steamed bread made by the present comparative example can be stored for 8 to 16 weeks; compared with those of examples 5 to 6 and comparative examples 6 to 7, the frozen steamed bread is poor in color, glossiness and appearance state, and has a small specific volume, the taste is not significantly different from that of ordinary frozen steamed bread, this may be because the too small amount of added formula is not enough to achieve the effects of improving the quality of the frozen steamed bread and increasing the frozen storage quality of the frozen steamed bread, and the formula proportion still needs to be further optimized.

TABLE 1
Texture Quality Changes of Frozen Cooked Noodles Made By Examples 1
to 4 and Frozen Cooked Noodles Made By Comparative Examples 1 to 5
During Frozen Storage (unit: g)

| | | 2 weeks | 4 weeks | 6 weeks | 12 weeks | 24 weeks |
|---|---|---|---|---|---|---|
| Example 1 | Hardness | 2899 | 2779 | 2770 | 2620 | 2500 |
| | Elasticity | 0.898 | 0.890 | 0.889 | 0.869 | 0.851 |
| | Chewiness | 1599 | 1501 | 1480 | 1403 | 1355 |
| Example 2 | Hardness | 2850 | 2750 | 2625 | 2585 | 2496 |
| | Elasticity | 0.895 | 0.901 | 0.918 | 0.903 | 0.896 |
| | Chewiness | 1551 | 1564 | 1587 | 1470 | 1399 |
| Example 3 | Hardness | 2737 | 2755 | 2607 | 2410 | 2327 |
| | Elasticity | 0.898 | 0.901 | 0.890 | 0.887 | 0.855 |
| | Chewiness | 1590 | 1438 | 1506 | 1459 | 1380 |
| Example 4 | Hardness | 2811 | 2807 | 2698 | 2440 | 2578 |
| | Elasticity | 0.920 | 0.917 | 0.918 | 0.901 | 0.893 |
| | Chewiness | 1536 | 1581 | 1473 | 1399 | 1210 |
| Comparative | Hardness | 2533 | 2544 | 2389 | 2089 | 1988 |
| Example 1 | Elasticity | 0.888 | 0.877 | 0.865 | 0.843 | 0.836 |
| | Chewiness | 1310 | 1219 | 1210 | 1118 | 1008 |
| Comparative | Hardness | 2688 | 2699 | 2608 | 2580 | 2570 |
| Example 2 | Elasticity | 0.901 | 0.897 | 0.890 | 0.888 | 0.868 |
| | Chewiness | 1440 | 1450 | 1401 | 1350 | 1219 |
| Comparative | Hardness | 2640 | 2680 | 2587 | 2465 | 2233 |
| Example 3 | Elasticity | 0.916 | 0.923 | 0.910 | 0.899 | 0.889 |
| | Chewiness | 1681 | 1518 | 1607 | 1570 | 1451 |
| Comparative | Hardness | 2678 | 2599 | 2470 | 2320 | 2200 |
| Example 4 | Elasticity | 0.890 | 0.888 | 0.879 | 0.869 | 0.850 |
| | Chewiness | 1349 | 1401 | 1303 | 1300 | 1255 |
| Comparative | Hardness | 2677 | 2589 | 2509 | 2420 | 2400 |
| Example 5 | Elasticity | 0.891 | 0.890 | 0.877 | 0.868 | 0.860 |
| | Chewiness | 1596 | 1561 | 1493 | 1409 | 1388 |

TABLE 2
Quality Changes of Frozen Steamed Bread Made By Examples 5 to 6 and
Frozen Steamed Bread Made By Comparative Examples 6 to 8 During Frozen Storage

| | | 2 weeks | 4 weeks | 6 weeks | 12 weeks | 24 weeks |
|---|---|---|---|---|---|---|
| Example 5 | Hardness/g | 899 | 900 | 851 | 752 | 702 |
| | Elasticity | 0.898 | 0.890 | 0.889 | 0.869 | 0.851 |
| | Chewiness/g | 795 | 799 | 791 | 702 | 625 |
| | Specific volume | 2.8 | 2.7 | 2.7 | 2.5 | 2.5 |
| | (ml/g) | | | | | |
| | Sensory score | 88 | 87 | 87 | 85 | 82 |
| Example 6 | Hardness/g | 905 | 888 | 869 | 789 | 720 |
| | Elasticity | 0.895 | 0.901 | 0.918 | 0.903 | 0.896 |
| | Chewiness/g | 751 | 723 | 701 | 658 | 612 |
| | Specific volume | 2.7 | 2.7 | 2.7 | 2.6 | 2.5 |
| | (ml/g) | | | | | |
| | Sensory score | 87 | 85 | 84 | 82 | 80 |
| Comparative | Hardness/g | 836 | 854 | 759 | 701 | 688 |
| Example 6 | Elasticity | 0.909 | 0.877 | 0.865 | 0.833 | 0.831 |
| | Chewiness/g | 689 | 690 | 605 | 580 | 535 |
| | Specific volume | 2.6 | 2.5 | 2.5 | 2.3 | 2.2 |
| | (ml/g) | | | | | |
| | Sensory score | 85 | 83 | 80 | 78 | 75 |
| Comparative | Hardness/g | 1101 | 998 | 889 | 830 | 799 |
| Example 7 | Elasticity | 0.901 | 0.888 | 0.880 | 0.801 | 0.798 |
| | Chewiness/g | 890 | 870 | 809 | 768 | 660 |
| | Specific volume | 2.3 | 2.2 | 2.1 | 2.0 | 2.1 |
| | (ml/g) | | | | | |
| | Sensory score | 82 | 80 | 78 | 75 | 74 |
| Comparative | Hardness/g | 850 | 800 | 788 | 702 | 690 |
| Example 8 | Elasticity | 0.902 | 0.903 | 0.890 | 0.833 | 0.829 |
| | Chewiness/g | 700 | 689 | 620 | 600 | 540 |
| | Specific volume | 2.6 | 2.5 | 2.4 | 2.4 | 2.3 |
| | (ml/g) | | | | | |
| | Sensory score | 86 | 85 | 82 | 78 | 77 |

### COMPARATIVE EXAMPLE 9

1. A quality-improved frozen cooked noodle formula of the present example is as follows: 9-1: 600 g of wheat flour, 280 g of water, 6.0 g of salt, 18 g of soy protein isolate; 9-2: 600 g of wheat flour, 280 g of water, 6.0 g of salt, 4 g of soybean phospholipid; 9-3: 600 g of wheat flour, 280 g of water, 6.0 g of salt, 12 g of soybean oil; 9-4: 600 g of wheat flour, 280 g of water, 6.0 g of salt, 6 g of soybean polysaccharide.

2. A preparation method for the quality-improved frozen cooked noodles of the present example comprises the following steps:

the aforementioned formula components are dissolved into the water, homogenizing, emulsification and sufficiently blended, and the blend and 600 g of wheat flour are then mixed into a vacuum dough mixing machine and agitated for 445 seconds; after being taken out and placed under room temperature for rest for 15 minutes, the dough is rolled into a 2.0 mm dough sheet, the dough sheet is cut into noodles, the noodles are weighed, steamed for 1 minute, showered, cooked for 4 minutes, cooled, quickly frozen, packaged and stored under −18° C., and the following indexes are periodically measured.

Texture Indexes: including a texture profile parameter and a tensile parameter, and representing the hardness, elasticity, tensile strength and other properties of noodles (see Table 3);

When four types of improved frozen cooked noodles made by the present example are stored under the condition of −18° C., the storage times are each about 12 weeks.

TABLE 3
Texture Quality of Frozen Cooked Noodles Made By Comparative Example 9
(Unit: g)

| | | 2 weeks | 4 weeks | 6 weeks | 12 weeks | 24 weeks |
|---|---|---|---|---|---|---|
| Soy protein isolate | Hardness | 2895 | 2920 | 2801 | 2650 | 2509 |
| (comparative | Elasticity | 0.898 | 0.890 | 0.882 | 0.855 | 0.839 |
| example 9-1) | Breaking | 26.2 | 26.0 | 25.5 | 24.1 | 22.0 |
| | strength | | | | | |
| Soybean | Hardness | 2900 | 2890 | 2812 | 2708 | 2511 |
| phospholipid | Elasticity | 0.901 | 0.902 | 0.889 | 0.868 | 0.850 |
| (comparative | Breaking | 25.9 | 26.5 | 26.0 | 25.1 | 23.9 |
| example 9-2) | strength | | | | | |
| Soybean oil | Hardness | 2850 | 2788 | 2692 | 2602 | 2424 |
| (comparative | Elasticity | 0.910 | 0.909 | 0.911 | 0.895 | 0.884 |
| example 9-3) | Breaking | 25.5 | 25.0 | 24.4 | 23.8 | 23.2 |
| | strength | | | | | |
| Soybean | Hardness | 2701 | 2680 | 2601 | 2520 | 2450 |
| polysaccharide | Elasticity | 0.899 | 0.890 | 0.885 | 0.868 | 0.860 |
| (comparative | Breaking | 24.8 | 24.2 | 23.3 | 22.2 | 21.6 |
| example 9-4) | strength | | | | | |

It can be seen from table 3 that the several types of soybean components which are respectively added in certain aspects to improve the quality of frozen cooked noodles to a certain degree, for example, the soy protein significantly increases the hardness of noodles; the soybean phospholipid has an influence on the longitudinal strength (tensile strength) of the noodles; the addition of the soybean oil only improves the elasticity index of the noodles; although the addition of the soybean polysaccharide decreases the hardness of the noodles, the main influence of the soybean polysaccharide on the noodles is the utilization of good water-holding property and gelation property of its own, so that the moisture migration rate in the noodles is decreased and the magnitude of ice crystal change is small in the process of frozen storage, so this is reflected in the smooth change tendency of the related indexes. Therefore, optimal products cannot be obtained by adding any combination or one of the several types of soybean components. The present disclosure reasonably proportions the amounts of added related components and achieves an optimal improvement effect on the quality of frozen cooked noodles by scientific verification.

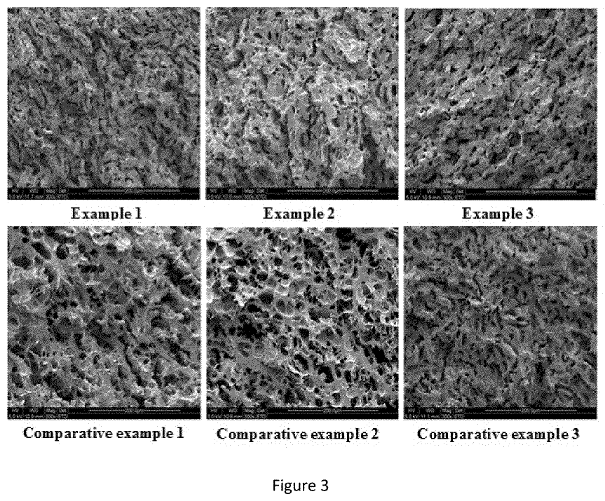

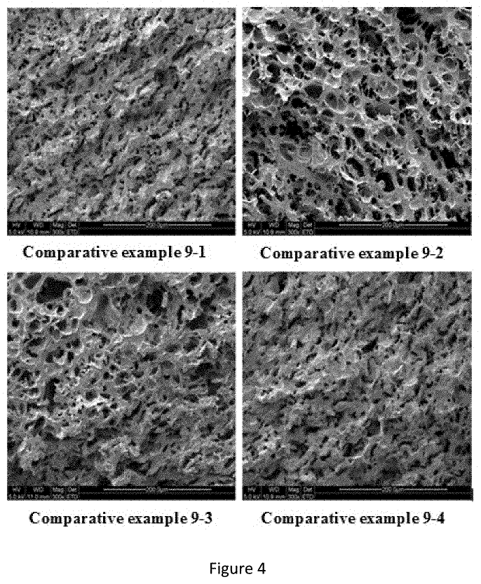

It can be known from FIGS. 3 and 4 that selecting ten samples in comparative example 1, comparative example 2, comparative example 3, example 1, example 2, example 3 and comparative examples 9-1, 9-2, 9-3 and 9-4 as representatives, it can be seen from the micrographs of morphologies and distributions of ice crystals in frozen cooked noodles within the same certain frozen storage time range that all the formed ice crystals of the samples corresponding to examples 1, 2 and 3 are fine and uniform and that the internal networks are densely connected, which can help realize the long-term stable frozen storage of the products. It is also proved from the internal changes of the products that the formula data provided by the present disclosure are effective.

In the present disclosure, all the equipment (including but not being limited to a German IKA RW 20 digital overhead stirrer, a German IKA T 18 digital high speed homogenizer, a vacuum dough mixing machine sold by Zhengzhou Dongfang Naomu Food Machinery Co., Ltd., noodle making equipment sold by Chengdu (Taiwan) Solatek Precision Machinery Co., Ltd., a Joyoung induction cooker, a Japanese SANYO refrigerator, a Haier refrigerator, etc.) and reagents used are purchased from the market.

The numerical method in the industry can be adopted for some environmental conditions and physical and chemical tests of product intermediates and final products in the process of production.

A test method for quality indexes of frozen cooked soybean base noodles and frozen steamed soybean base bread:

(1) Analysis of Texture Profile Properties of Noodles:

The following method is adopted to carry out an analysis of texture profile physical properties for noodles, comprising the following steps: the reheated noodles (20 cm per noodle) are spread in a plastic wrap, and two noodles are randomly taken out each time to undergo the test of texture profile properties. A physical property analyzer used is a texture analyzer produced by British Stable Micro Systems; the speeds of a probe HDP/PFS before, in the process of and after the test are kept at 0.8 mm/s, the time interval is 1 second, compression is performed twice, and each batch of samples are tested ten times in parallel.

(2) Analysis of Texture Profile Properties of Steamed Bread:

The following method is adopted to carry out an analysis of texture profile physical properties for steamed bread, comprising the following steps: five pieces of cooked steamed bread are randomly selected and cooled for 20 minutes, a slicer is used to cut the five pieces of steamed bread into 20 mm uniform slices, and two middle slices are selected for measurement in order to reduce errors. During texture profile measurement, the speeds of a probe P/25 before, in the process of and after the test are respectively 3.0 mm/s, 1.0 mm/s and 5.0 mm/s, deformation is 50%, induction force is 5 g, and each batch of samples are measured at least five times.

(3) Analysis of Tensile Property of Noodles:

The following method is adopted to carry out an analysis of tensile property for noodles, comprising the following steps: the reheated noodles (20 cm per noodle) are spread in a plastic wrap, and one noodle is randomly taken out each time to undergo the test of tensile property. A physical property analyzer used is a texture analyzer produced by British SMS; the speeds of a probe A/SPR before, in the process of and after the test are respectively 2 mm/s, 2 mm/s and 10 mm/s, and each batch of samples are tested ten times in parallel.

(4) Measurement of Specific Volume of Steamed Bread:

Steamed bread is cooled under normal temperature for 20 minutes, and is covered by a wet gauze in order to prevent the loss of moisture. The volume of the steamed bread is measured by adopting a rapeseed isovolumetric replacement method (GB/T 20981-2007), mass is measured by using a scale, and each sample is measured five times in parallel.

(5) Sensory Evaluation and Analysis:

Twenty or more volunteers (taking the differences of ages, regions, professions and other conditions into consideration) are selected for each sensory evaluation; according to revised SB/T 10068-92 “noodle quality evaluation standard”, as shown in table 4, the seven indexes of frozen cooked noodles, such as taste, flavor, appearance state, etc., are scored, and a mean value of comprehensive scores is obtained; according to the standard of table 5, sensory evaluation is performed for the frozen steamed bread, a mean value of comprehensive scores is obtained, and results are compared.

TABLE 4
Sensory Scoring Standard for Frozen Cooked Noodles

| | Full | |
|---|---|---|
| | score | Evaluation standard |
| Color and | 5 | This refers to the color and brightness of noodles; white, milky and |
| glossiness | | creamy noodles are scored as 4 to 5; medium is scored as 2-4; and |
| | | gray and dark noodles are scored as 1-2. |
| Appearance | 10 | This refers to the surface smoothness and expansion degree of |
| state | | noodles; noodles with a compact, smooth noodle structure are |
| | | scored as 8.5-10; medium is scored as 6-8.5; and noodles with |
| | | rough, wrinkled or expanded surface are scored as 1-6. |
| Palatability | 30 | This refers to force which is required by teeth to bite off a plurality |
| | | of noodles; noodles requiring moderate force are scored as 25-30; |
| | | medium is scored as 15-25; and over-hard noodles or over-soft |
| | | noodles are scored as 1-15. |
| Toughness | 25 | This refers to the chewiness and elasticity of noodles being chewed; |
| | | chewy and highly elastic noodles are scored as 20-25; medium is |
| | | scored as 10-20; and noodles with insufficient chewiness and poor |
| | | elasticity are scored as 1-10. |
| Stickiness | 20 | This refers to the tooth sticking degree of noodles being chewed; |
| | | palatable and non-sticky noodles being chewed are scored as 15-20; |
| | | medium is scored as 10-15; and noodles with poor palatability and |
| | | high stickiness are scored as 1-10. |
| Smoothness | 5 | This refers to the smooth degree of noodles in mouth; smooth |
| | | noodles are scored as 4.5-5; medium is scored as 3-4.5; and noodles |
| | | with poor smoothness are scored as 1-3. |
| Flavor | 5 | This refers to the flavor of noodles being tasted; noodles with |
| | | pleasant fragrance are scored as 4.5-5; noodles which almost do not |
| | | have foreign flavor are scored as 3-4.5; and noodles with foreign |
| | | flavor are scored as 1-3. |

TABLE 5
Sensory Scoring Standard for Frozen Steamed Bread

| | Full | |
|---|---|---|
| | score | Evaluation standard |
| Surface | 15 | Milky, yellowed and dark pieces of steamed bread are respectively |
| whiteness | | scored as 10-15, 5-10 and 0-5. |
| Smoothness | 10 | Steamed bread with smooth surface is scored as 6-10; steamed |
| | | bread with shrunk, spotted and slightly sunken surface is scored as |
| | | 3-6; severely shrunk steamed bread is scored as 0-3. |
| Internal | 15 | Steamed bread with uniform white color is scored as 10-15; |
| whiteness | | steamed bread which is nonuniform in color and is partially |
| | | yellowed is scored 5-10; and steamed bread with obvious gray |
| | | spots and yellow spots is scored as 0-5. |
| Internal | 15 | Steamed bread with uniform and fine pores is scored as 10-15; |
| structure | | steamed bread with medium pores is scored as 5-10; and steamed |
| | | bread with nonuniform pores or few pores is scored as 0-5. |
| Resilience | 10 | Steamed bread which has good resilience and chewiness after |
| | | being pressed by a finger is scored as 6-10; medium is scored as |
| | | 3-6; and steamed bread with poor resilience and chewiness is scored |
| | | as 0-3. |
| Stickiness | 10 | Steamed bread which does not stick teeth and is palatable when |
| | | chewed is scored as 6-10; slightly sticky steamed bread is scored |
| | | as 3-6; and steamed bread which is unpalatable and sticky when |
| | | chewed is scored as 0-3. |
| Softness | 10 | Steamed bread which is palatable and soft and can be easily |
| | | swallowed is scored as 6-10; steamed bread with moderate |
| | | hardness is scored as 3-6; and steamed bread which is dry, hard |
| | | and difficult to swallow is scored as 0-3. |
| Flavor | 15 | Steamed bread with wheat fragrance and bean fragrance is scored |
| | | as 10-15; medium is scored as 5-10; and steamed bread with |
| | | offensive flavor and bean flavor is scored as 0-5. |

Although the present disclosure has been disclosed as above with the preferred examples, the examples are not intended to limit the present disclosure. Any person skilled in the technology can make various changes and embellishments without departing from the spirit and scope of the present disclosure, so the protection scope of the present disclosure shall be based on the definition of the claims.

What is claimed is:

1. A soybean base wheat flour-based frozen food formula, comprising wheat flour, water, salt and a soybean base formula; the soybean base formula comprises soy protein isolate, soybean phospholipid, soybean oil and soybean polysaccharide; and a mass ratio of the soybean protein isolate to the soybean phospholipid to the soybean oil to the soybean polysaccharide is (4-6):(1-2):(2-4):(1-2).

2. The soybean base wheat flour-based frozen food formula of claim 1, wherein mass of the soy protein isolate is 1.0 to 5.0 percent of a total mass of the wheat flour, mass of the soybean phospholipid is 0.2 to 1.0 percent of the total mass of the wheat flour, mass of the soybean oil is 0.5 to 2.0 percent of the total mass of the wheat flour, mass of the soybean polysaccharide is 0.5 to 1.0 percent of the total mass of the wheat flour, mass of the salt is 0 to 1.0 percent of the total mass of the wheat flour, and mass of the water is 45 to 50 percent of the total mass of the wheat flour.

3. A quality improvement formula for wheat flour-based frozen food, wherein the quality improvement formula is a soybean base formula comprising soy protein isolate, soybean phospholipid, soybean oil and soybean polysaccharide.

4. The quality improvement formula for wheat flour-based frozen food according to claim 3, wherein a protein content of the soybean protein isolate is 90 percent or more; and the soybean polysaccharide is soluble soybean polysaccharide set forth in a Chinese Standard for Food Additives-GB2760-2014.

5. The quality improvement formula for wheat flour-based frozen food according to claim 3, wherein the soy protein isolate is capable of being substituted by soy protein concentrate with a protein content of 70 to 90 percent; the soybean phospholipid is capable of being substituted by rapeseed phosphatide or egg lecithin; and the soybean oil is capable of being substituted by vegetable oil with rich unsaturated fatty acid.

6. The quality improvement formula for wheat flour-based frozen food according to claim 4, wherein the soybean protein isolate is capable of being substituted by soybean protein concentrate with a protein content of 70 to 90 percent; the soybean phospholipid is capable of being substituted by rapeseed phospholipid or egg yolk phospholipid; and the soybean oil is capable of being substituted by vegetable oil with rich unsaturated fatty acid.

7. The quality improvement formula for wheat flour-based frozen food according to claim 5, wherein the vegetable oil with rich unsaturated fatty acid comprises palm oil, peanut oil and rapeseed oil.

8. The quality improvement formula for wheat flour-based frozen food according to claim 3, wherein the wheat flour-based frozen food comprises frozen cooked noodles, frozen dumplings, frozen steamed bread and frozen steamed stuffed buns.

9. A method of using the quality improvement formula for wheat flour-based frozen food according to claim 3, comprising: dissolving soybean base components in water; performing processing by a high-speed homogenizer; agitating and heating in a boiling water bath to make compound soybean milk; and adding the made compound soybean milk added into wheat flour.

10. A method of using the quality improvement formula for wheat flour-based frozen food according to claim 4, comprising: dissolving soybean base components in water; performing processing by a high-speed homogenizer; agitating and heating in a boiling water bath to make compound soybean milk; and adding the made compound soybean milk added into wheat flour.

11. A method of using the quality improvement formula for frozen flour food according to claim 5, comprising: dissolving soybean base components in water; performing processing by a high-speed homogenizer; agitating and heating in a boiling water bath to make compound soybean milk; and adding the made compound soybean milk added into wheat flour.

12. A method of using the quality improvement formula for frozen flour food according to claim 6, comprising: dissolving soybean base components in water; performing processing by a high-speed homogenizer; agitating and heating in a boiling water bath to make compound soybean milk; and adding the made compound soybean milk added into wheat flour.

13. A method of using the quality improvement formula for frozen flour food according to claim 3, comprising: dissolving soybean base components in water; performing 1 to 2 minutes of processing by a high-speed homogenizer under a rotational speed of 10000 to 15000 r/min; and agitating and heating for uniform blending under a speed of 500 to 1000 r/min to make compound soybean milk.

14. A soybean base wheat flour-based frozen food formula, comprising wheat flour, water, salt and a soybean base formula, wherein the soybean base formula comprises soy protein isolate, soybean phospholipid, soybean oil and soybean polysaccharide.

15. The soybean base wheat flour-based frozen food formula according to claim 14, wherein mass of the soy protein isolate is 1.0 to 5.0 percent of a total mass of the wheat flour, mass of the soybean phospholipid is 0.2 to 1.0 percent of the total mass of the wheat flour, mass of the soybean oil is 0.5 to 2.0 percent of the total mass of the wheat flour, mass of the soybean polysaccharide is 0.5 to 1.0 percent of the total mass of the wheat flour, mass of the salt is 0 to 1.0 percent of the total mass of the wheat flour, and mass of the water is 45 to 50 percent of the total mass of the wheat flour.

16. The soybean base wheat flour-based frozen food formula according to claim 14, characterized in that the mass ratio of the soy protein isolate to the soybean phospholipid to the soybean oil to the soybean polysaccharide is (4-6):(1-2):(2-4):(1-2).

17. The soybean base frozen flour food formula according to claim 14, characterized in that the mass ratio of the soybean protein isolate to the soybean phospholipid to the soybean oil to the soybean polysaccharide is (4-6):(1-2):(2-4):(1-2).
